(19) United States
(12) Patent Application Publication
(10) Pub. No.: US 2025/0137931 A1
(43) Pub. Date: May 1, 2025

(54) SPECTROMETER AND METHOD OF DETECTING A SPECTRUM

(71) Applicant: NATIONAL UNIVERSITY OF SINGAPORE, Singapore (SG)

(72) Inventor: Guangya ZHOU, Singapore (SG)

(73) Assignee: NATIONAL UNIVERSITY OF SINGAPORE, Singapore (SG)

(21) Appl. No.: 18/689,539

(22) PCT Filed: Sep. 1, 2022
(86) PCT No.: PCT/SG2022/050637

§ 371 Date: Mar. 6, 2024

(30) Foreign Application Priority Data
Sep. 6, 2021 (SG) 10202109715X

(51) Int. Cl. G01N 21/65

(52) U.S. Cl. CPC G01N 21/65

(57) ABSTRACT

A spectrometer for detecting an electromagnetic (EM) wave spectrum having one or more wavelength components within a spectral band of interest, a method of detecting an electromagnetic (EM) wave spectrum having one or more wavelength components within a spectral band of interest, and a method of constructing the spectrometer. The method comprises the steps of creating dispersed images of an entrance aperture on a plane of an exit aperture, such that respective images at the different wavelength components are offset by different amounts of displacements along a direction of dispersion; gathering a first EM wave energy incident on the entrance aperture to an EM detector; gathering a second EM wave energy that exits the exit aperture to the at least one single-pixel detector; and measuring the output of the EM detector and the output of the at least one single pixel detector for reconstructing the EM wave spectrum taking into account an intensity distribution of an incident EM wave on the entrance aperture.

### FIELD OF INVENTION

The present invention relates broadly to a spectrometer for detecting an electromagnetic (EM) wave spectrum having one or more wavelength components within a spectral band of interest, a method of detecting an electromagnetic (EM) wave spectrum having one or more wavelength components within a spectral band of interest, and a method of fabricating the spectrometer. In a non-limiting example embodiment, the present invention can be applied to Raman spectroscopy.

### BACKGROUND

Any mention and/or discussion of prior art throughout the specification should not be considered, in any way, as an admission that this prior art is well known or forms part of common general knowledge in the field.

As shown schematically in FIG. 1, conventional optical spectrometers use a narrow entrance slit (typically with a micrometer-scale width), which severely limits the light gathering power (i.e. the throughput) of the spectrometer. As shown, the light gathering power or throughput of a spectrometer is defined as the product of the entrance area and the solid angle subtended at this entrance. Throughput is a critical performance indicator that determines the spectrometer's signal-to-noise ratio (SNR) and speed of spectrum measurement. Due to the nature of its design, enlarging the slit width increases the throughput however it inevitably lowers the spectrometer's resolution. There are two reported approaches that can be used to enhance the spectrometer's throughput without sacrificing its resolution. One is the coded aperture approach as shown in FIG. 2, which employs a fixed encoding mask at the spectrometer entrance aperture and a camera to receive the dispersed images of the encoded aperture. The spectrum is then reconstructed by image processing. Another approach was described by the present inventor in WO 2021/029827, more particularly a high-throughput spectrometer as shown in FIG. 3, where two encoders are placed respectively at the entrance and exit aperture planes of the spectrometer. At least one of the two encoders are dynamically adjustable or programmable, thus allowing the spectrometer to reconstruct the spectrum using only a single-pixel photodetector. Compared with the coded aperture approach, the approach in WO 2021/029827 has the same high-throughput and high-resolution advantages, and yet it removes the requirement of using an image sensor in the spectrometer system. Hence, the approach is highly desirable for many applications where image sensors are not available or prohibitively expensive, such as at IR wavelengths or requiring ultrafast temporal resolution.

Amongst optical spectroscopy techniques, Raman spectroscopy is a powerful technology for label-free detection and analysis of biological and biochemical molecules. However, the Achilles' heel of conventional Raman technology is the laser induced sample fluorescence emission, which is several orders of magnitude higher in intensity than that of the Raman scattering, thereby drowning out the desired Raman signals. To overcome this problem, time-gated (TG) Raman spectroscopy with a pulsed laser has been proposed, which utilizes the fact that Raman scattering is ultrafast and almost instantaneous with the laser pulses and yet the fluorescent emission is relatively slow and has a time delay at nano-second scale after the laser pulses. As shown schematically in FIG. 4, a precise nanosecond or sub-nanosecond time gate is open for detection immediately after each laser pulse and is closed during most of the laser pulse repetition period. The scheme can effectively detect the Raman signals while fluorescence background is largely suppressed.

A schematic of a TG Raman spectroscopy setup is shown in FIG. 5 (a). Although Raman spectroscopy works well with a visible pulsed laser and the induced Raman spectra are indeed within the visible to near infrared (VNIR) wavelengths where silicon-based image sensors are ubiquitous and low-cost, the requirement of ultrafast time-gated detection makes such conventional image sensors useless in TG Raman spectroscopy applications. As shown in the figure, expensive gated intensified charged-coupled device (ICCD) cameras (with built-in micro channel plate (MCP) image intensifiers) or streak cameras are typically used in TG Raman setups, thus making the system costly. High speed single-pixel detectors such as photomultiplier tubes (PMTs) and single photon avalanche diodes (SPADs) are also reported to be used in TG Raman systems. However, as shown in FIG. 5 (b), these have to be mechanically scanned a single wavelength at a time by using motorized stages to either move the detector at the exit of the monochromator or rotate the grating inside the monochromator to obtain the full Raman spectrum. Low SNR due to the loss of multiplexing advantage, reductions in robustness, compactness, and field usability due to the bulky mechanical motorized stages in the system, and prolonged measurement time are among the major draw backs of these single-pixel TG Raman systems.

Embodiments of the present invention seek to address at least one of the above problems.

### SUMMARY

In accordance with a first aspect of the present invention, there is provided a spectrometer for detecting an electromagnetic (EM) wave spectrum having one or more wavelength components within a spectral band of interest, comprising:
an entrance aperture;
an exit aperture;
a dispersion and imaging optics configured to create dispersed images of the entrance aperture on a plane of the exit aperture, such that respective images at the different wavelength components are offset by different amounts of displacements along a direction of dispersion;
at least one single-pixel detector, each single-pixel detector sensitive to one or more of the wavelength components;
an EM detector;
a first collection optics configured to gather a first EM wave energy incident on the entrance aperture to the EM detector;
a second collection optics configured to gather a second EM wave energy that exits the exit aperture to the at least one single-pixel detector; and
a measurement unit configured to measure the output of the EM detector and the output of the at least one single pixel detector for reconstructing the EM wave spectrum taking into account an intensity distribution of an incident EM wave on the entrance aperture.

In accordance with a second aspect of the present invention, there is provided a method of detecting an electromagnetic (EM) wave spectrum having one or more wavelength components within a spectral band of interest, the method comprising the steps of:
creating dispersed images of an entrance aperture on a plane of an exit aperture, such that respective images at the different wavelength components are offset by different amounts of displacements along a direction of dispersion;
gathering a first EM wave energy incident on the entrance aperture to an EM detector;
gathering a second EM wave energy that exits the exit aperture to the at least one single-pixel detector; and
measuring the output of the EM detector and the output of the at least one single pixel detector for reconstructing the EM wave spectrum taking into account an intensity distribution of an incident EM wave on the entrance aperture.

In accordance with a third aspect of the present invention, there is provided a method of constructing the spectrometer of the first aspect.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating an optical spectrometer.

FIG. 2 shows a schematic drawing illustrating a coded aperture optical spectrometer.

FIG. 3 shows a schematic drawing illustrating a high-throughput spectrometer, where two encoders are placed respectively at the entrance and exit aperture planes of the spectrometer.

FIG. 4 shows a graph illustrating a precise nanosecond or sub-nanosecond time gate is open for detection immediately after each laser pulse and is closed during most of the laser pulse repetition period, for extracting Raman scattering signals with minimum fluorescence signals.

FIG. 5A shows a schematic drawing illustrating a TG Raman spectroscopy setup using an ICCD camera.

FIG. 5B shows a schematic drawing illustrating a TG Raman systems using high speed single-pixel detectors such as photomultiplier tubes (PMTs) and single photon avalanche diodes (SPADs).

FIG. 6 shows a schematic drawing illustrating a spectrometer according to an example embodiment.

FIG. 7 shows a schematic drawing illustrating the 0^{th} order diffracted light from the dispersion optics being collected and received at the 1^{st} detector, according to an example embodiment.

FIG. 8 shows a schematic drawing illustrating that for the j^{th} measurement (j=1˜M), an encoding pattern is set at the entrance slit and the weightage of the k^{th} encoding pixel is aⱼₖ, according to an example embodiment.

FIG. 9 shows a schematic drawing illustrating summation of signals from all the slits, according to an example embodiment.

FIG. 10 shows a schematic drawing illustrating a spectrometer according to an example embodiment.

FIG. 11 shows a schematic drawing illustrating a spectrometer according to an example embodiment.

FIG. 12 shows a schematic drawing illustrating that in some applications, when the light spot on a detector is larger than its photosensitive area, cascading using multiple single-pixel detectors can be used in an example embodiment.

FIG. 13 shows a schematic drawing illustrating the working principle of a high-throughput spectrometer in time-resolved (TR) Raman spectroscopy applications.

FIG. 14 shows a schematic drawing illustrating TR Raman system according to an example embodiment.

FIG. 15A shows a schematic drawing illustrating that, right after each laser pulse, the output of detector D3 going through a discriminator produces a triggering pulse to start the two time-to-amplitude converters (TACs), according to an example embodiment.

FIG. 15B shows a schematic drawing illustrating that, when started, the TAC's voltage is linearly ramped on a capacitor and stops only when a photon is detected, according to an example embodiment.

FIG. 16 shows a schematic drawing illustrating that, with a series of Raman shift spectra obtained at various time delays, a 3D Raman shift spectra data cube can be constructed representing time-resolved Raman shift, according to an example embodiment.

FIG. 17 shows a flow-chart illustrating a method of detecting an electromagnetic (EM) wave spectrum having one or more wavelength components within a spectral band of interest, according to an example embodiment.

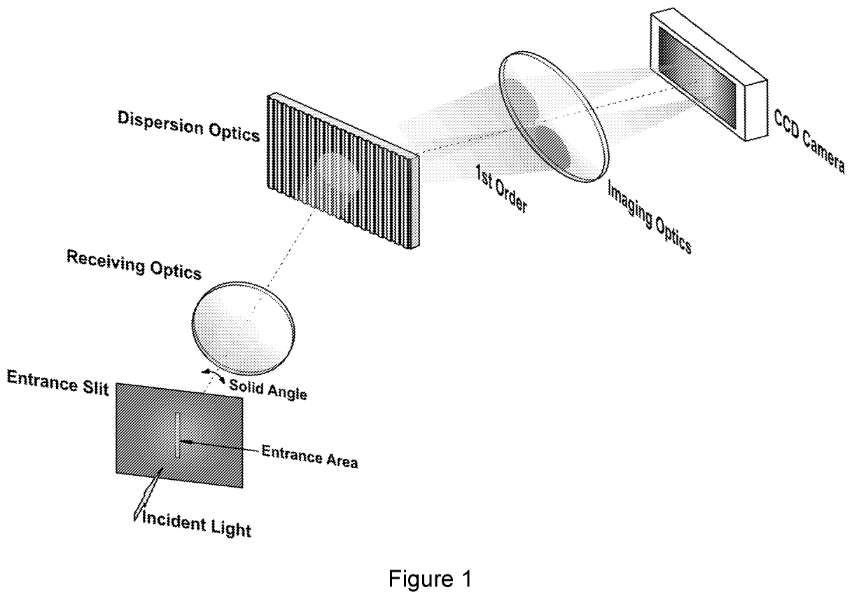

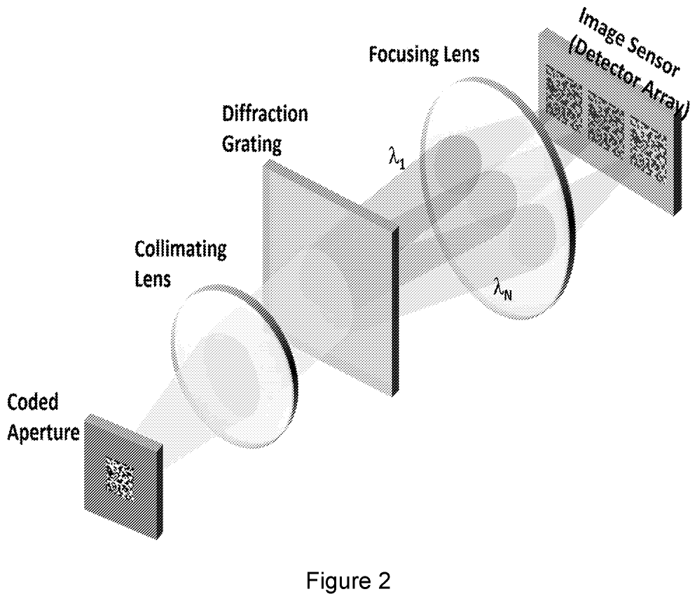

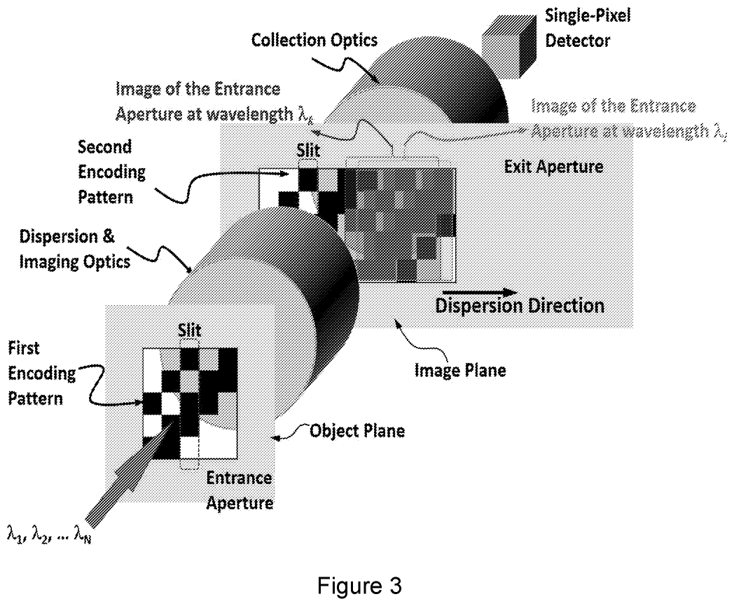

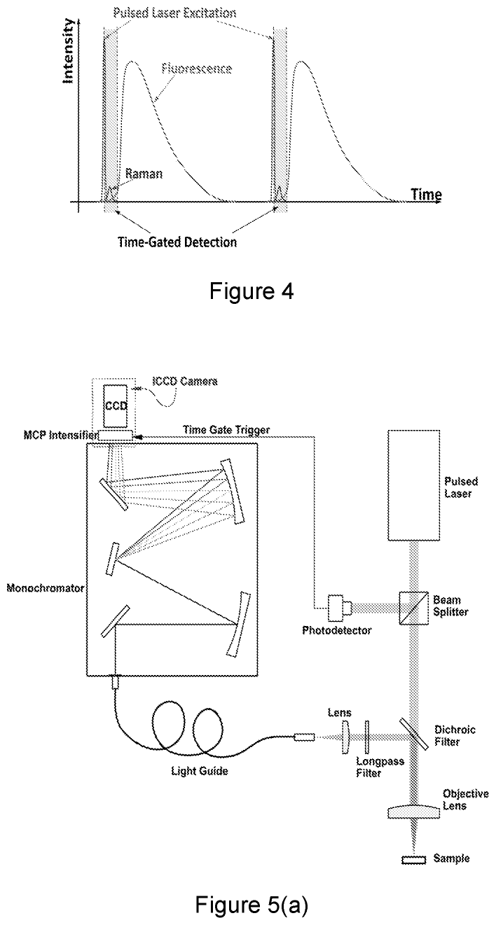

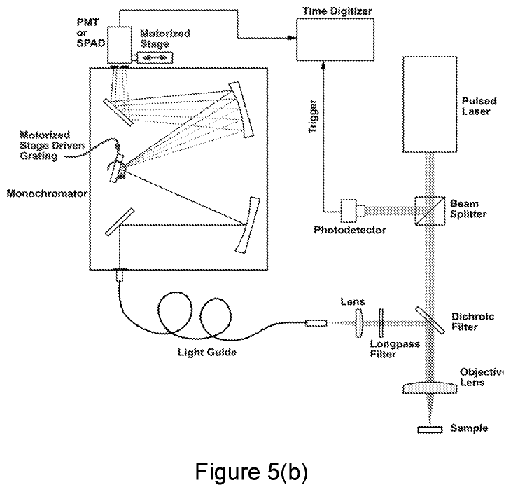

### DETAILED DESCRIPTION

It has been recognized by the present inventor that the high-throughput spectrometer designs in WO 2021/029827 are optimized if the illumination on the spectrometer entrance aperture is uniform. Any non-uniformity illumination would translate into system noises and thus could reduce SNR of the spectrometer. This uniform illumination requirement can also complicate the spectrometer fore-optics design and potentially increase the cost of the fore-optics. An example embodiment of the present invention can provide an apparatus and method of removing the uniform illumination limitation so that the spectrometer can have a better SNR and be more robust in operation. An example embodiment of the present invention can also provide an apparatus and the method of applying single-pixel high-throughput spectrometers in time-gated or time-resolved Raman spectroscopy systems.

In an example embodiment a type of high throughput single-pixel spectrometer is provided, which is enhanced by employing a unique design to remove the limitation of uniform illumination on the entrance aperture. As a result, an example embodiment of the present invention can greatly simplify the sampling optics or fore optics design, thus making the sampling process for spectroscopic detection and chemical/biochemical analysis easier, more robust, and more convenient for field uses. An example embodiment of the present invention can also have all of the distinct advantages that it (1) is not based on optical interferometers hence is more robust and less sensitive to external disturbances; (2) has an enlarged entrance aperture thus allowing a significantly enhanced light-gathering power, and hence is capable of detection of very weak signals; (3) uses single-pixel photodetector hence can be cost-effectively operated in applications where image sensors/detector arrays are expensive; (4) has the multiplexing advantage hence supporting high SNR detection.

An example embodiment for high throughput single-pixel spectrometers can be implemented in a Raman spectroscopy system. The advantages of using an example embodiment of the present invention in a Raman system include: (1) extremely large spectrometer throughput allowing easier detection of weak Raman scattered signals; (2) can use lasers that are not focused, hence leading to low power density on sample thus less harmful to delicate samples; (3) removing the requirement for precise focusing of laser spot on sample also enhances the robustness of the equipment and facilitates field application, (3) laser illumination on the sample can have a large area (e.g. millimeter by millimeter) allowing faster and easier detection for inhomogeneous samples like powders and pills owing to integrated averaging effect. (4) single-pixel detection makes it easier and cost-effective to implement time-gated or time-resolved Raman spectroscopy to suppress fluorescence background.

It is noted that an example embodiment of the present invention can be used in IR and Raman spectroscopic sensing in various application domains such as in food and beverage quality assessment, gas sensing, environmental monitoring, precision agriculture, industrial process control, internet of things, biomedical point of care testing, drug screening, and many others.

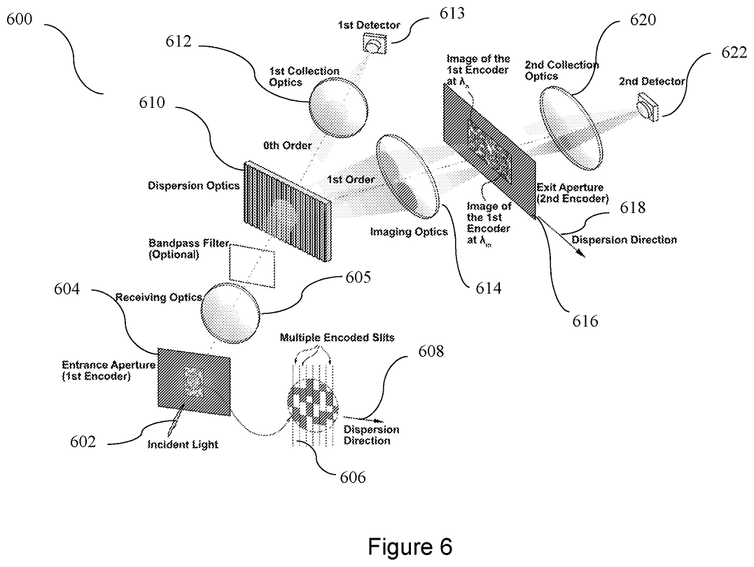

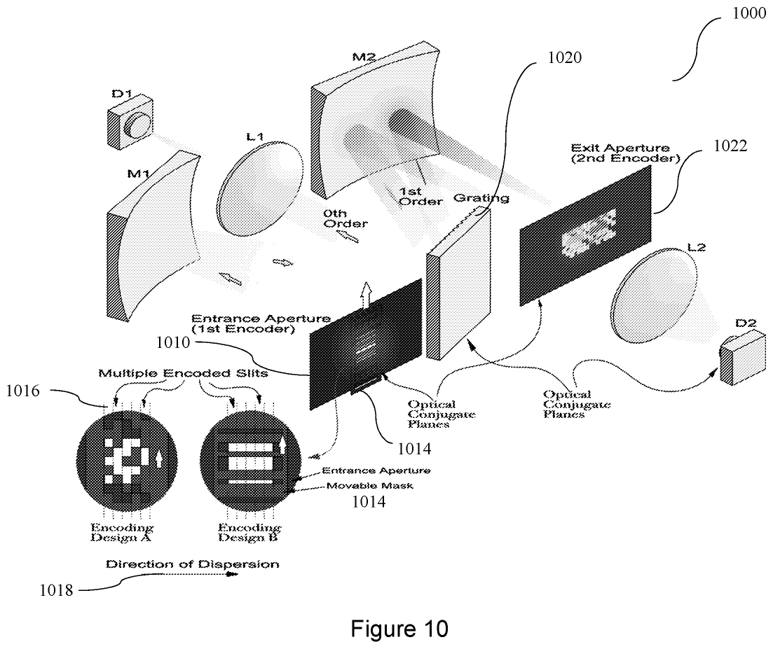

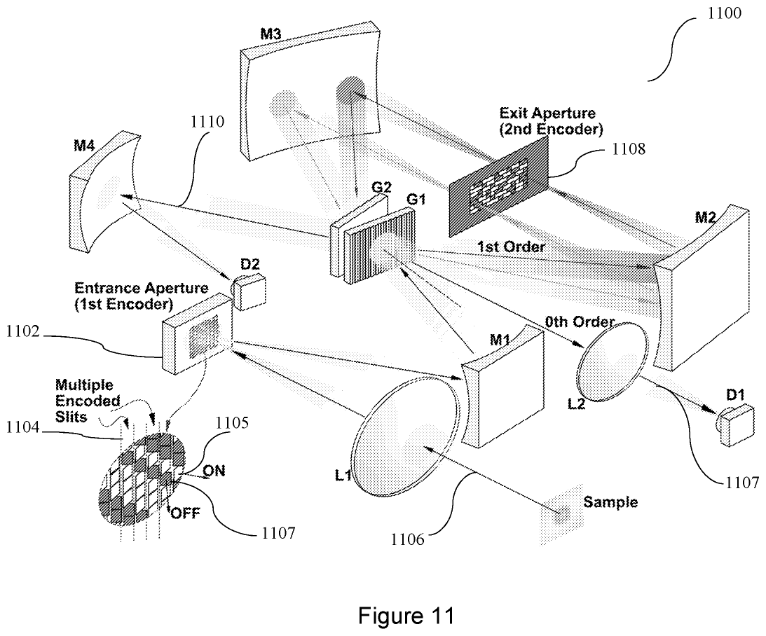

A schematic of a spectrometer 600 according to an example embodiment is shown in FIG. 6. It will be appreciated that FIG. 6 also illustrates the construction of the spectrometer 600 by providing and disposing the various components of the spectrometer 600. As shown, an EM wave 602 illuminates the entrance aperture/1^{st} encoder 604 of the spectrometer 600. The entrance aperture/1^{st} encoder 604 has a significantly enlarged aperture size and comprises at least one slit 606 that is spatially encoded along its length direction, i.e. along a direction substantially transverse to the direction of dispersion 608. The entrance aperture/1^{st} encoder 604 can be transmissive (as shown in FIG. 6 or in the example embodiment in FIG. 10) or reflective (as shown in the example embodiment in FIG. 11). A field lens (not shown) can be placed near the entrance aperture/1^{st} encoder 604 of the spectrometer 600 to facilitate the pupil matching with the optics (not shown) before the entrance aperture 604. After the entrance aperture/1^{st} encoder 604, a receiving optics 605 receives the EM wave and directs it to the dispersion optics 610. The dispersion optics 610 contains at least one diffraction grating. The 0^{th}-order diffracted wave is not dispersed and is directed to the 1^{st} collection optics 612, which collects the wave energy and directs it to the 1^{st} detector 613. The first detector may comprise, for example, a single-pixel detector or an imaging camera. A selected non-zeroth order diffracted wave (typically, it will be either +1^{st} or −1^{st} order) is collected by an imaging optics 614 and focused to the exit aperture/2^{nd} encoder 616 plane, where dispersed images of the encoded entrance aperture 604 are formed. The exit aperture/2^{nd} encoder 616 comprises a plurality of slits arranged in the direction of dispersion, where each slit is spatially encoded along a direction substantially transverse to the direction of dispersion 618. A field lens (not shown) can be placed near the exit aperture/2^{nd} encoder 616 to facilitate the pupil matching with the 2^{nd} collection optics 620 after the exit aperture 616. The wave after the exit aperture/b 2^{nd} encoder 616 is thus encoded for a second time, and is collected by a 2^{nd} collection optics 620 and directed to the 2^{nd} detector 622, here a single-pixel detector. In the description below, it will be shown that the spatial intensity distribution of the EM wave 602 at the entrance aperture 604 is obtained from the detector 613 coupled to the 1^{st} collection optics 612 and the EM wave's spectrum is reconstructed from the 2^{nd} detector 622 coupled to the 2^{nd} collection optics 620, taking into account the intensity distribution of the EM wave 602 at the entrance aperture 604.

Slight modification to the system shown in FIG. 6 is possible to achieve the same functionality in various embodiments. For example, instead of detecting the zeroth order diffracted light from the dispersion optics, one can use a beam-splitter before the dispersion optics to split the EM wave into two portions. One portion is directed to the 1^{st} collection optics 612 and detector 613, and the other is directed to the dispersion optics 610, imaging optics 614, exit aperture/2^{nd} encoder 616, 2^{nd} collection optics 620, and 2^{nd} detector 622. In this modified system according to an example embodiment, the spatial intensity distribution of the EM wave 602 at the entrance aperture 604 is again obtained from the detector 613 coupled to the 1^{st} collection optics 612, and the EM wave's spectrum is reconstructed from the measurements of the 2^{nd} detector 622 coupled to the 2^{nd} collection optics 620, taking into account the intensity distribution of the EM wave 602 at the entrance aperture 604.

The incident EM radiation contains N number of spectral components λ₁, λ₂, . . . , λᵢ, . . . , λ_{N} (i=1˜N) within the spectral range of interest [λₘᵢₙ, λₘₐₓ] of the spectrometer 600. If the EM radiation has a broader spectral range than the range of interest, a bandpass filter can be inserted in the spectrometer 600 to cut-off all components outside of [λₘᵢₙ, λₘₐₓ]. The shape of the radiation spectrum is represented by a column vector X′=[x₁′ x₂′ . . . xᵢ′ . . . x_{N}′]^{T}, where xᵢ′ is the relative intensity of radiation at wavelength λᵢ. It is noted that the relative value of xᵢ′ with respect to those at other wavelengths is important to the shape of the spectrum, while the absolute value of xᵢ′ is not.

Firstly, a single encoded slit 606 is considered for simplicity. The slit 606 is encoded by a total number of K pixels along its length direction. The EM radiation from a sample is directed to the entrance slit 606 of the spectrometer 600, where the illumination along the slit 606 length direction might not be uniform due to a number of factors including the uniformity of the light source, conditions of optical alignment and focusing, and homogeneity of the sample. On the other hand, for spectroscopy applications, the input radiation spectrum at each encoding pixel along the slit 606 should be the same. Therefore, the total radiation intensity at the k^{th} encoding pixel can be written as Iₖ′(Σᵢ₋₁^{N}xᵢ′), where Iₖ′ is a scaling factor to reflect the nonuniform illumination along the slit.

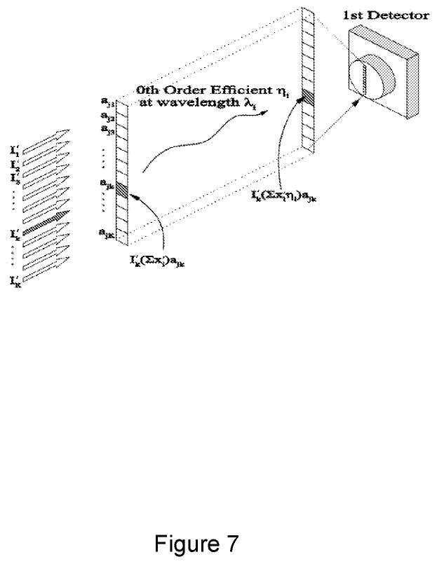

At jth measurement (j=1˜M), an encoding pattern is set at the slit 606, where the weightage of the k^{th} encoding pixel is denoted as αⱼₖ (with αⱼₖ−1 for a transparent pixel or aⱼₖ=0 for an opaque pixel). As shown in FIG. 6, the 0^{th} order diffracted light from the dispersion optics 610 is collected and received at the 1^{st} detector 613. As shown in FIG. 7, the measured signal at the 1^{st} detector can be written as:

$${u}_{j} = {\sum }_{k - 1}^{K} {I}_{k}^{′} ( {\sum }_{i - 1}^{N} {x}_{i}^{′} {η}_{i} ) {a}_{jk} = {\sum }_{k - 1}^{K} {a}_{jk} ( {c}_{1} {I}_{k}^{′} ) , \qquad ( 1 )$$

where ηᵢ is the efficiency of detection at the wavelength λᵢ. And, ηᵢ might include a number of factors including 0^{th} order diffraction efficiency from the grating, optical losses along the 0^{th} order path, and photodetector efficiency at wavelength λᵢ. It should be noted that in above equation the term (Σᵢ₌₁^{N}xᵢ′ηᵢ) has a value independent of the encoding process, and this term is defined as a coefficient c₁. Next, a new vector is defined to represent the spectrum without changing its shape:

$$X = {[ {x}_{1} {x}_{2} … {x}_{k} … {x}_{N} ]}^{T} = {[ \frac{{x}_{1}^{′}}{{c}_{1}} \frac{{x}_{2}^{′}}{{c}_{1}} … \frac{{x}_{k}^{′}}{{c}_{1}} … \frac{{x}_{N}^{′}}{{c}_{1}} ]}^{T} = \frac{1}{{c}_{1}} {X}^{′} , \qquad ( 2 )$$

and a new scaling factor Iₖ=c₁Iₖ′. With these definitions and after a complete cycle of encoding process from j=1 to M, the Eq. (1) can be written into a matrix form.

$$U = AI , \qquad ( 3 )$$

where U is a M×1 measurement vector, A is a M×K encoding matrix, and I is a K×1 vector representing intensity scaling at each pixel. It is understood that the vector I can be solved using the following:
(a) If M=K, A is a square matrix and invertible, then I=A⁻¹U.
(b) If M<K, the vector I can be solved using compressed sensing algorithms and/or regression with regularization.
(c) If M>K, the vector I can be obtain using a number of approaches, including Moore-Penrose generalised inverse.

It is noted that the total radiation intensity at a given pixel number k can be written either as Iₖ′(Σᵢ₌₁^{N}xᵢ′) or lₖ(Σᵢ₌₁^{N}xᵢ), and they are equal. Consequently, the overall radiation intensity incident onto the spectrometer slit is given by:

$${I}_{total} - ( {\sum }_{k = 1}^{K} {I}_{k} ) ( {\sum }_{i = 1}^{N} {x}_{i} ) - ( {\sum }_{k = 1}^{K} {I}_{k}^{′} ) ( {\sum }_{i = 1}^{N} {x}_{k}^{′} ) , \qquad ( 4 )$$

It is also noted that the spectrum X by its definition in Eq. (2) is normalised by the following equation:

$${\sum }_{i = 1}^{N} {x}_{i} {η}_{i} = 1 , \qquad ( 5 )$$

Hence, in some spectroscopy sensing cases where comparing spectra is necessary for example obtaining an absorption spectrum by comparing the spectra of the light source and the light transmitted through the sample, the spectrum X need to be scaled by a factor of (Σₖ₌₁^{K}Iₖ) to reflect the actual amount of total radiation intensity falling onto the entrance slit 606.

Next, the measurement of the spectrum X is considered. As shown in FIG. 6, a selected diffraction order (1^{st} order as an example here) is collected by an imaging optics 614 and focused to an exit aperture 616, where a 2^{nd} encoding mask is located. In an example embodiment, the 1^{st} encoding mask pattern at the entrance aperture 604 of the spectrometer 600 is dynamically adjustable and the 2^{nd} encoding pattern at the exit aperture 616 is fixed. However, other configurations are also possible in different example embodiment, for example the 1^{st} encoding pattern is fixed while the 2^{nd} is adjustable or both the 1^{st} and 2^{nd} encoding patterns are adjustable. The light passing through the exit aperture 616/2^{nd} encoder is encoded for a second time and then collected by another set of collection optics 620 and sent to the 2^{nd} detector 622.

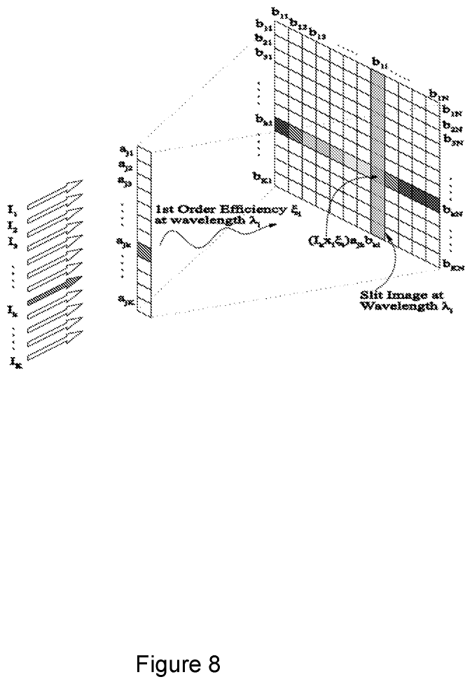

As shown in FIG. 8, for j^{th} measurement (j=1˜M), an encoding pattern is set at the entrance slit 606 and the weightage of the k^{th} encoding pixel is aⱼₖ. The total light intensity passing through the slit, the 2^{nd} encoder, and received by the 2^{nd} detector 622 is:

$${v}_{j} = {\sum }_{i = 1}^{N} {\sum }_{k = 1}^{K} ( {I}_{k} {x}_{i} {ξ}_{i} ) {a}_{jk} {b}_{ki} , \qquad ( 6 )$$

where bₖᵢ is the weight (or portion) of the light intensity at wavelength λᵢ from kth pixel on the entrance slit that can pass through the 2^{nd} encoder and ξᵢ is the efficiency of detection at the wavelength λᵢ at the 2^{nd} detector. Again, ξᵢ might include a number of factors including 1^{st} order diffraction efficiency from the grating, optical losses along the 1^{st} order path, as well as the photodetector efficiency at wavelength λᵢ. It is important to note that ξᵢ is a system parameter that remains constant once the spectrometer 600 is constructed and thus can be readily calibrated with lasers with known wavelengths and intensities. With this in mind, it is defined:

$${y}_{i} = {x}_{i} {ξ}_{i} or Y = {[ {x}_{1} {ξ}_{1} {x}_{2} {ξ}_{2} … {x}_{i} {ξ}_{i} … {x}_{N} {ξ}_{N} ]}^{T} , \qquad ( 7 )$$

Consequently, the Eq. (6) can be rewritten in a matrix form:

$${v}_{j} = [ {a}_{j 1} {a}_{j 2} … {a}_{jK} ] [ \begin{matrix}{I}_{i} & 0 & … & 0 \\ 0 & {I}_{2} & … & 0 \\ \cdot & \cdot & … & \cdot \\ \cdot & \cdot & … & \cdot \\ \cdot & \cdot & … & \cdot \\ 0 & 0 & … & {I}_{K}\end{matrix} ] [ \begin{matrix}{b}_{11} & {b}_{11} & … & {b}_{1 N} \\ {b}_{21} & {b}_{22} & … & {b}_{2 N} \\ \cdot & \cdot & … & \cdot \\ \cdot & \cdot & … & \cdot \\ \cdot & \cdot & … & \cdot \\ {b}_{K 1} & {b}_{K 2} & … & {b}_{K N}\end{matrix} ] [ \begin{matrix}{y}_{1} \\ {y}_{2} \\ \cdot \\ \cdot \\ \cdot \\ {y}_{N}\end{matrix} ] , \qquad ( 8 )$$

After a complete set of measurement from j=1 to M, the above equation can be written in a matrix form:

$$V = AOBY , \qquad ( 9 )$$

where V is a M×1 measure vector, A is the 1^{st} encoding matrix of dimension M×K, O is a diagonal matrix of dimension K×K and contains the scaling factor Iₖ obtained from Eq. (3), B is the 2^{nd} encoding matrix of dimension K×N, and Y is a N×1 column vector containing spectrum of the radiation, respectively. In the above equation, the matrices A and B are known by the spectrometer encoder designs and the matrix O can be obtained by measuring the 0^{th} order diffraction using the 1^{st} detector 613. Then, the above linear equations can be solved for Y when a sufficient number of measurements are made. Depending on the total number of measurements M and the number of unknown spectral components N (i.e. whether M=N, M<N, or M>N), a number of methods can be used for obtaining the solution, which include matrix inversion, generalised inversion, compressed sensing, regression, and generalised regression with regularisation. Once the vector Y is solved, the radiation spectrum X can be obtained using Eq. (7).

In the following description M=N is set as an example. It is also important to note that (AOB) is a M×N matrix and its rank is also affected by the total number of encoding pixels K on the entrance slit. To maximise the rank of (AOB), the number K should be equal to or greater than N. In the following description we will set K=N.

In Eq. (9), A matrix is determined by the 1^{st} encoding pattern design that is precisely decided by the programmable encoder at the slit, and this matrix is known and accurate. The scaling factor matrix O is determined by measuring the 0^{th} order diffracted light using the 1^{st} detector and obtained using a computational algorithm such as compressed sensing. This matrix is also relatively accurate. However, the B matrix is affected by the aberrations of the spectrometer optics as well as alignment errors especially between the encoded slit and the 2^{nd} encoding mask, and thus may contain large errors that could affect the spectrum reconstruction results. Fortunately, the errors in B matrix are systematic, which means that they can be calibrated and removed through proper calibration methods provided that the spectrometer optics once constructed is unchanged.

One possible calibration procedure can be as follows. (1) Use a tunable laser as the spectrometer input, and set the laser wavelength to λᵢ (i=1, 2, . . . , N) and its intensity to 1. (2) Record the measurements Zᵢ for a complete set of encoding patterns. Then, we have:

$${Z}_{i} = AO [ \begin{matrix}{b}_{11} & {b}_{11} & … & {b}_{1 i} & … & {b}_{1 N} \\ {b}_{21} & {b}_{22} & … & {b}_{2 i} & … & {b}_{2 N} \\ \cdot & \cdot & … & \cdot & … & \cdot \\ \cdot & \cdot & … & \cdot & … & \cdot \\ {b}_{N 1} & {b}_{N 2} & … & {b}_{Ni} & … & {b}_{N N}\end{matrix} ] [ \begin{matrix}0 \\ 0 \\ \cdot \\ 1 ( {i}^{th} row ) \\ \cdot \\ \cdot \\ 0\end{matrix} ] , \qquad ( 10 )$$

During the calibration process, one can use the method of averaging to suppress the detector noise by repeating the step (2) for a number of times. Then, from the above equation, the i^{th} column of the B matrix can be easily obtained through the following equation:

$$[ \begin{matrix}{b}_{1 i} \\ {b}_{2 i} \\ \cdot \\ \cdot \\ {b}_{Ni}\end{matrix} ] = {O}^{- 1} {A}^{- 1} {Z}_{i} , \qquad ( 11 )$$

(3) Repeat the steps (1) and (2) for a new wavelength λᵢ₊₁, until all columns of the B matrix are calibrated. It is also noted that the B matrix can also be calibrated using other methods. For example, by feeding the spectrometer with a series of input EM waves with known spectra, and then employ machine learning algorithms to calibrate the B matrix by minimising the errors between the reconstruct spectra and know spectra. Once B is calibrated, one can then proceed to measure unknown EM spectra with enhanced accuracy and SNR using Eqs. (3) and (9).

Next, it is considered that the entrance aperture now contains a total number of Ns encoded slits. One can treat each individual slit using the method described above. Considering the fact that the 1^{st} detector receives the 0^{th} order diffracted light from all the slits, the Eq. (3) now becomes:

$$U = {\sum }_{l = 1}^{Ns} {A}_{l} {I}_{l} , \qquad ( 12 )$$

where Aₗ and Iₗ denote the encoding matrix and intensity scaling vector for the l^{th} slit, respectively. This equation can be further casted into a block matrix form.

$$U = [ {A}_{1} {A}_{2} … {A}_{Ns} ] [ \begin{matrix}{I}_{1} \\ {I}_{2} \\ … \\ {I}_{Ns}\end{matrix} ] = \overline{A} \cdot \overline{I} , \qquad ( 13 )$$

with the measurement vector U and encoding matrix Ā know, the vector Ī or I₁, I₂, . . . , I_{Ns} can be solved. It is noted that the vector Ī now contains N×Ns unknowns, it may take a long time to complete N×Ns measurements. In this case, a smaller number of measurements can be conducted, and compressed sensing algorithms can be used to find the Ī. This procedure is usually accurate, because the intensity distribution at the entrance aperture is indeed slowly varying and hence the vector Ī is sparse in some basis.

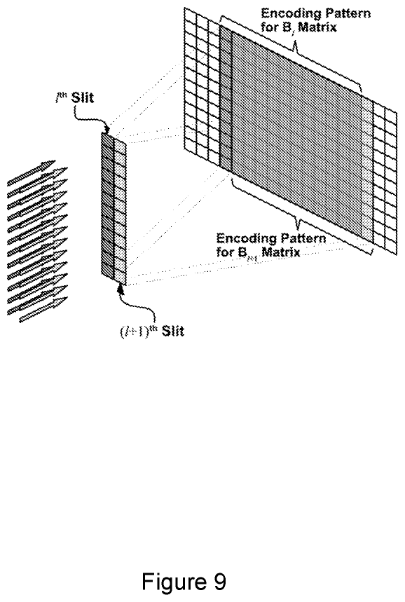

As shown in FIG. 6, the 2^{nd} detector 622 receives all light passing through the exit aperture/2^{nd} encoder 616 in the 1^{st} order diffracted pathway from the grating, in this example embodiment. Further highlighted schematically in FIG. 9, the measurement equation Eq. (9) then becomes a summation from all the slits:

$$V = {\sum }_{l = 1}^{Ns} {A}_{l} {O}_{l} {B}_{l} Y , \qquad ( 14 )$$

where V is the measurement vector, Aₗ, Oₗ and Bₗ respectively denote the 1^{st} encoding matrix, intensity scaling matrix, and 2^{nd} encoding matrix for the l^{th} slit, and Y is a vector contains the spectrum X. Again, this equation can be further casted into a block matrix form.

$$V = [ {A}_{1} {A}_{2} … {A}_{Ns} ] [ \begin{matrix}{O}_{1} & 0 & … & 0 \\ 0 & {O}_{2} & … & 0 \\ … & … & … & … \\ 0 & 0 & … & {O}_{Ns}\end{matrix} ] [ \begin{matrix}{B}_{1} \\ {B}_{2} \\ … \\ {B}_{Ns}\end{matrix} ] Y = ( \overline{A} \cdot \overline{O} \cdot \overline{B} ) Y , \qquad ( 15 )$$

In the above equation, the matrix B̅ can be calibrated by calibrating B₁, B₂, . . . and B_{Ns} for each individual encoded slits using the method established in the single slit case describe before. Once B̅ is calibrated, it contains system parameters that won't change unless the spectrometer optics is adjusted. Then, one can then proceed to measure unknown EM spectra with enhanced accuracy and SNR using Eqs. (13) and (15) in a way similar to the single encoded slit case.

In summary, the spectrometer according to an example embodiment works in the following way. At least one encoded slit in the spectrometer entrance aperture plane are used to generate a series of encoding patterns to encode the incident EM wave. For each encoding pattern, a 1^{st} detector 613 is used to record the total intensity of the 0^{th} order diffracted wave, and a 2^{nd} detector 622 is used to record the total intensity of a non-zeroth order diffracted wave (usually +1 or −1 order) that pass through the 2^{nd} encoder. After a sufficient number of measurements are recorded, the spectrum of the EM wave can be reconstructed by solving the Eqs. (13) and (15) using a number of methods including matrix inversion, generalised inversion, regression, and regression with regularisation.

The key advantages of the spectrometer according to an example embodiment include: (1) can conveniently operate at any EM wavelength band including near IR, mid IR, far IR, as well as UV, and DUV owing to the low-cost single-pixel photodetectors used to record the total intensity of the diffracted wave; (2) has multiplexing advantage resulting in high SNR; (3) has an extremely high throughput owing to the large entrance aperture used, thus enabling the detection of very weak EM wave signals; (4) removes the requirement for uniform illumination of the entrance aperture, thus greatly simplifying the spectrometer fore optics design and making sampling process for spectroscopic sensing easier and more convenient for field uses.

Particularly for Raman spectroscopy, the spectrometer according to an example embodiment has the following significant advantages: (1) extremely large spectrometer throughput allowing easier detection of weak Raman scattered signals; (2) can use lasers that are not focused, hence leading to low power density on sample thus less harmful to delicate samples; (3) removing the requirement for precise focusing of laser spot on sample also enhances the robustness of the equipment and facilitate field application. (3) laser illumination on sample can have a large area (millimeter by millimeter) allowing faster and easier detection for inhomogeneous samples like powders and pills owing to integrated averaging effect. (4) single-pixel detector(s) make it easier and cost-effective to implement time-gated or time-resolved Raman spectroscopy to suppress fluorescence background.

An example embodiment of a spectrometer 1000 is shown in FIG. 10. It will be appreciated that FIG. 10 also illustrates the construction of the spectrometer 1000 by providing and disposing the various components of the spectrometer 1000. As shown, the entrance aperture 1010 is illuminated with an EM wave, a movable mask 1014 is placed immediately before or after the entrance aperture/1^{st} encoder 1010 and different encoding patterns are generated by moving the mask 1014. The movable mask 1014 contains a plural of encoded slits e.g. 1016, and the neighbouring slits can have a small gap or can be placed one immediately after another with zero gap. Each slit e.g. 1016 is encoded along its length direction, which is substantially transverse to the direction of dispersion 1018 as shown. All slits can have the same encoding pattern as shown in the design B or have different encoding patterns as shown in design A. The EM wave passing through the entrance aperture 1010 is thus encoded for the first time. The wave is then collected by a receiving optics (mirror M1) and dispersed by a dispersion optics 1020 (grating). The 0^{th} order diffracted wave from the dispersion optics 1020 is gathered by a 1^{st} collection optics (lens L1) and focused to a 1^{st} detector D1. A selected diffraction order (usually the 1^{st} order) wave from the dispersion optics 1020 is gathered and focused by an imaging optics (mirror M2) to an exit aperture/2^{nd} encoder 1022. The wave is then encoded for a second time. The wave passing through the exit aperture/2^{nd} encoder 1022 is then gathered by a 2^{nd} collection optics (lens L2) and focused to a 2^{nd} detector D2. here a single-pixel detector. As shown in the figure, the entrance aperture/1^{st} encoder 1010 and exit aperture/2^{nd} encoder 1022 form a pair of optical conjugate planes, and the grating 1020 surface and the photosensitive area on the detector D2 form another pair of optical conjugate planes. In this configuration, although the illumination area on the exit aperture/2^{nd} encoder can be large due to the dispersion effect, the spot on the detector D2 is just the image of the illuminated spot on the grating 1020 and thus can be made smaller as long as the optical magnification is smaller than one. A small light spot size on the single-pixel detector D2 (and also D1) is beneficial and facilitates a small photosensitive area detector design, which in turn results in less dark current noise and faster response speed. Additionally, a field lens can be placed near the exit aperture/2^{nd} encoder 1022 for pupil matching.

Another example embodiment of a spectrometer 1100 is shown in FIG. 11. It will be appreciated that FIG. 11 also illustrates the construction of the spectrometer 1100 by providing and disposing the various components of the spectrometer 1100. As shown, light from a sample is collected by a lens L1 and directed to the entrance aperture/1^{st} encoder 1102. The 1^{st} encoder is implemented using microelectromechanical systems (MEMS) technology, more specifically MEMS micromirror array technology. The 1^{st} encoder contains multiple encoded slits e.g. 1104, each is formed by a column of micromirrors. As shown in FIG. 11, when a micromirror e.g. 1105 rotates to its right (when viewed in the direction of the EM wave 1106), it directs the light falling on it into the receiving optics of the spectrometer 1100, and thus its corresponding pixel is in an “ON” state. On the contrary, when a micromirror e.g. 1107 rotates to the left, it directs the light away from the receiving optics of the spectrometer 1100, and thus its corresponding pixel is in an “OFF” state. The light reflected from all “ON” state micromirrors in the 1^{st} encoder is gathered by a receiving optics (mirror M1) and directed to a dispersion optics (grating G1). The 0^{th} order diffraction 1107 from the dispersion optics G1 is collected by a 1^{st} collection optics (lens L2) and directed to a 1^{st} detector D1. A selected non-zeroth diffraction order (usually +1 or −1 order) beams are directed from the dispersion optics G1 to an imaging optics (mirror M2) and focused to the exit aperture/2^{nd} encoder 1108 plane. Dispersed images of the entrance aperture/1^{st} encoder 1102 are produced here on the exit aperture/2^{nd} encoder 1108 plane. Light transmitted through the exit aperture/2^{nd} encoder 1108 is then collected by a 2^{nd} collection optics, which contains mirror M3, grating G2, and mirror M4. The grating G2 here reverses the dispersion produced by the dispersion optics G1 and combines beams with different wavelengths into a single beam 1110, which is then focused by the mirror M4 to the detector D2, here a single-pixel detector. Hence, on the photosensitive surface of D2, a de-magnified image of the entrance aperture 1102 is formed. This 2^{nd} collection optics design helps to reduce the required photosensitive area on the detector D2, which is desirable for high speed and low noise detection.

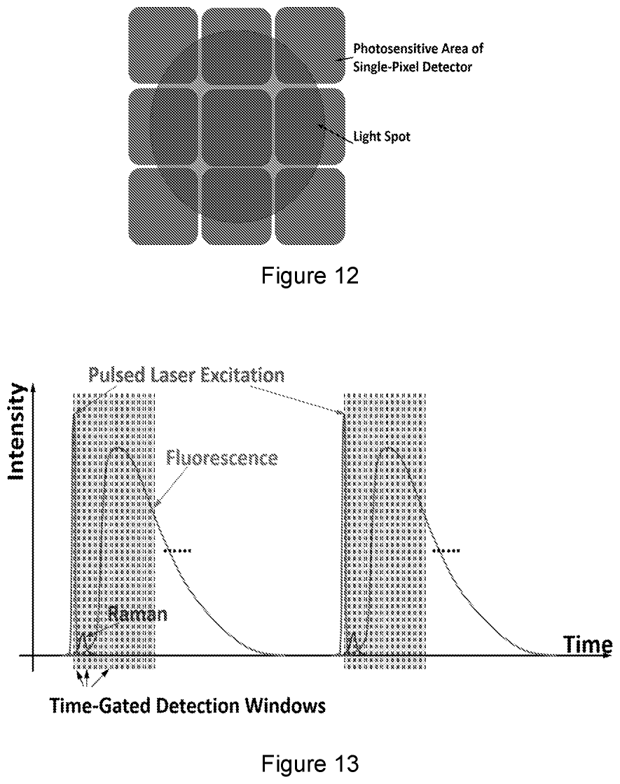

In the above example embodiments, detectors (613, 622, D1 and D2) can be single-pixel detectors such as photodiodes, avalanche photodiodes (APDs), single-photon avalanche diodes (SPADs), photon multiplier tubes (PMTs) and many others. In some applications when the light spot on a detector is larger than its photosensitive area, cascading using multiple single-pixel detectors can be used in an example embodiment, as shown in FIG. 12.

Next, the use of an example embodiment of a high-throughput spectrometer in time-resolved (TR) Raman spectroscopy applications will be described. As shown schematically in FIG. 13, TR Raman is an enhanced version of TG Raman. In TR Raman, a series of very short time-gated detection windows are opened one after another at varying time delays after each laser pulse, thus capturing an ultrafast sample spectra evolution (Raman plus fluorescence) over time. TR Raman is not only capable of suppressing fluorescence background but also allows to reveal other critical information of the sample such as fluorescence life time and materials in layered samples at different depths.

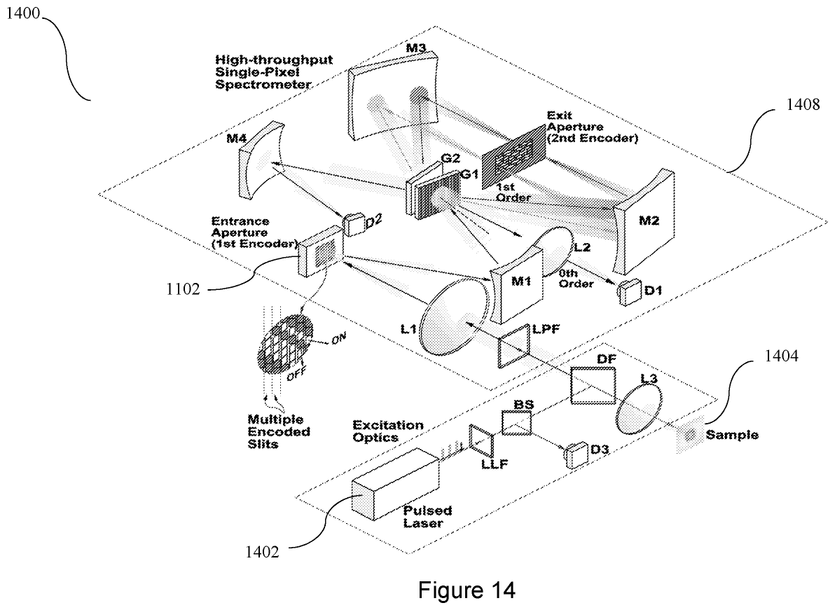

A TR Raman system 1400 according to an example embodiment is shown in FIG. 14. It will be appreciated that FIG. 14 also illustrates the construction of the spectrometer 1400 by providing and disposing the various components of the spectrometer 1400. Laser pulses from an excitation laser 1402 source go through a laser line filter LLF and split into two paths at the beamsplitter BS. On one path, laser pulses are directed to a photodetector D3 to generate electrical pulses for starting/triggering time-gated windows as well as system synchronization. On the other path, laser pulses are directed to the sample 1404 through a dichroic filter DF and lens L3. With the high throughput spectrometer design according to an example embodiment, focusing of the laser beam to a tiny spot on sample 1404 surface is not necessary. This unique property removes the requirements of precision optics in the excitation path and accurate sample alignment in traditional Raman spectrometer, and at the same time, reduces the risk of photon induced sample damage. The Raman scattered light is then collected by the lens L3, goes through the dichroic filter DF, and enters the high throughput single-pixel spectrometer 1408. As an example, the spectrometer 1408 is in the form of the spectrometer 1100 according to an example embodiment (compare FIG. 11) is employed here in the Raman system 1400) according to an example embodiment. The detector D1 records the 0^{th} order diffracted light signal, which is then used to reconstruction the intensity distribution on the entrance aperture/1^{st} encoder 1102. The detector D2 records the 1^{st} order diffracted light signal, and in combination with the information of the intensity distribution on the entrance aperture/1^{st} encoder 1102, it determines the Raman scattered light spectrum. It is noted that any spectrometer according to various embodiments of the present invention can be used in different example embodiments, as will be appreciated by a person skilled in the art. Additional filters can be added to the system to further enhance the Raman system performance, for example adding a long pass filter for the detection of Stokes Raman signals.

It is noted that for TR Raman system according to an example embodiment and using a visible pulsed laser, the detector D1 in the high throughput spectrometer 1408 shown in FIG. 14 can be a single-pixel detector or a conventional arrayed image sensor. The reason why a conventional image sensor can be used here is further highlighted below. The main function of D1 is to capture the intensity distribution at the entrance aperture, and this detection is at visible wavelength and does not require ultrafast time-gated function. Hence, a common CCD or CMOS image sensor can be suitable for the usage here. In the description of an example embodiment below, it is still preferred for the detector D1 to be a single-pixel detector such as PMT or SPAD owing to their high internal gain and high sensitivity.

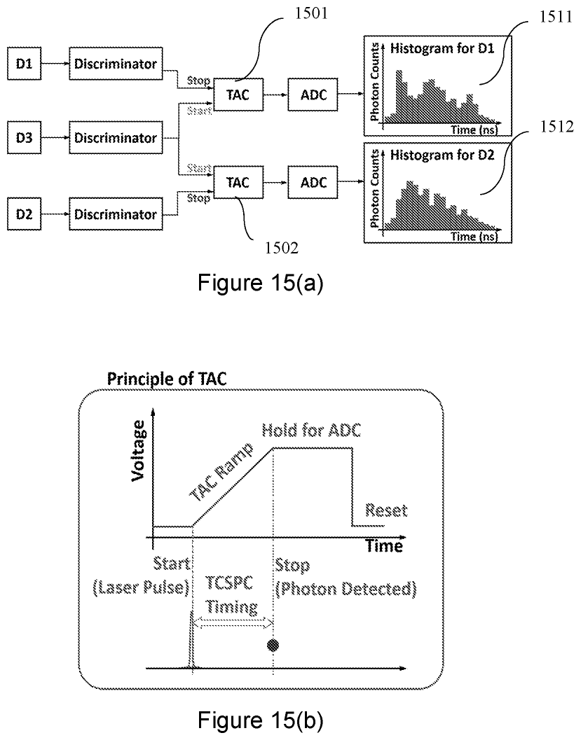

With single-pixel detectors used in the Raman system according to an example embodiment, time correlated single photon counting (TCSPC) technology can be directly applied to obtain the TR Raman spectrum. As shown in FIG. 15 (a), right after each laser pulse, the output of detector D3 going through a discriminator produces a triggering pulse to start the two time-to-amplitude converters (TACs) 1501, 1502. As shown in FIG. 15 (b), when started, the TAC's 1501, 1502 voltage is linearly ramped on a capacitor and stops only when a photon is detected by the detector D1 and D2 respectively. The output voltage of the TAC 1501, 1502 is then held for the analog-to-digital converter (ADC) to record the time of this single photon detection event. After a sufficient number of laser pulses, a histogram is produced, which represents the number of detected photons at various time delays after the laser pulse. The histograms for D1 and D2, respectively, are equivalent to the detected light intensity as a function time delay. As shown in FIG. 15 (a), the detector D1 and D2 stop, respectively, the upper and lower TACs 1501, 1502 and produce two histograms 1511, 1512, respectively, over time. The data processing is then as described above for the example embodiments of the high-throughput spectrometers. Briefly, the D1 histogram 1511 is processed to reconstruct the spatial intensity distribution at the entrance aperture, while the D2 histogram 1512 is processed to reconstruct the Raman shift spectrum.

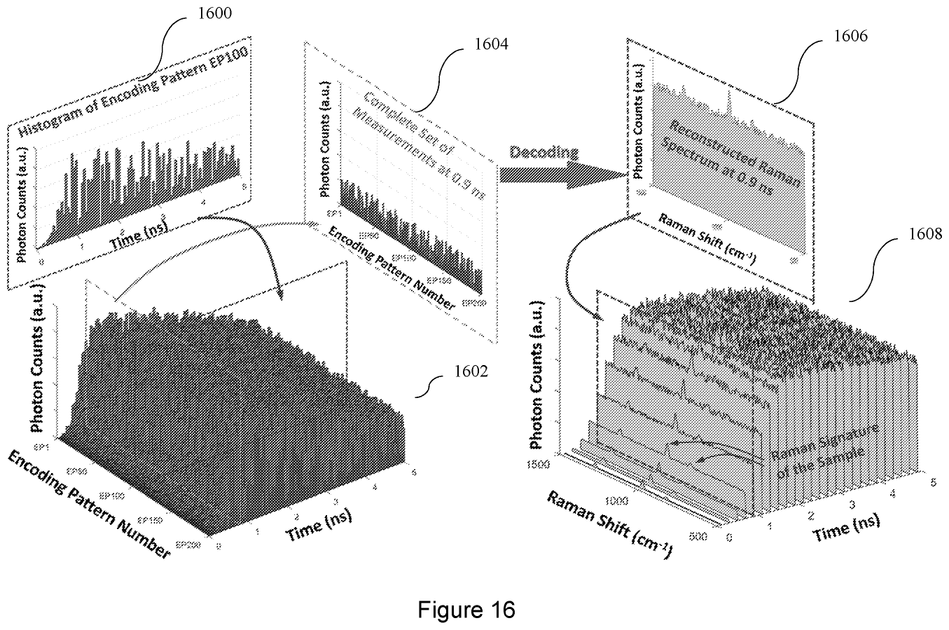

To further illustrate the data processing algorithm according to an example embodiment, the D2 histogram 1512 is used as an example. During operation, the high-throughput spectrometer according to an example embodiment generates a series of encoding patterns at its entrance aperture, and at each encoding pattern a histogram is produced with the hardware discussed in FIG. 15. As shown in FIG. 16, the recorded histograms e.g. 1600 are then combined to form a histogram data cube 1602 (shown on the left of FIG. 16), with the x-axis being the encoding pattern number, y-axis being the time delay, and the z-axis being the number of photon counts. The 3D histogram data cube 1602 is then “cut” at various time delays, as indicated at numeral 1604. Each time ‘slice’ 1604 then represents the recorded measurements for a complete set of encoding patterns at the entrance aperture of the high throughput spectrometer, which can be subsequently decoded into a Raman shift spectrum 1606. The Raman shift spectrum e.g. 1606 at each time delay can then be reconstructed using the methods described above according to an example embodiment. As shown in the right side of FIG. 16, with a series of Raman shift spectra e.g. 1606 obtained at various time delays, a 3D Raman shift spectra data cube 1608 can be constructed representing time-resolved Raman shift. It is noted that with single-pixel detectors such as PMT and SPAD used in the Raman system according to an example embodiment, it is cost effective to achieve picosecond-level time-gated detection windows, thus making high temporal resolution in TR Raman possible. Additionally, the high-throughput spectrometer design according to an example embodiment with an enlarged aperture size further enhances the throughput and thus improves the SNR of the TR Raman spectra.

The key advantages of a spectrometer according to an example embodiment include that it: (1) can conveniently operate at any EM wavelength band including near IR, mid IR, far IR, as well as UV, and DUV owing to the low-cost single-pixel photodetectors used; (2) has multiplexing advantage resulting in high SNR; (3) has an extremely high throughput owing to the large entrance aperture used, thus enabling the detection of very weak EM wave signals; (4) removes the requirement for uniform illumination of the entrance aperture, thus greatly simplifying the spectrometer foreoptics design and making sampling process for spectroscopic sensing easier and more convenient for field uses.

Particularly for Raman spectroscopy, a spectrometer according to an example embodiment can have the following significant advantages: (1) extremely large spectrometer throughput allowing easier detection of weak Raman scattered signals; (2) can use lasers that are not focused, hence leading to low power density on sample thus less harmful to delicate samples; (3) removing the requirement for precise focusing of laser spot on sample also enhances the robustness of the equipment and facilitate field application; (3) laser illumination on sample can have a large area (millimetre by millimetre) allowing faster and easier detection for inhomogeneous samples like powders and pills owing to integrated averaging effect; (4) single-pixel make it easier and cost-effective to implement time-gated or time-resolved Raman spectroscopy to suppress fluorescence background; (5) Combination of TCSPC with MEMS-micromirror-based encoded entrance aperture makes high sensitive TG/TR Raman detection with essentially no mechanical moving parts.

{The following is a usual “repetition” of the claim language in the description.}

In one embodiment, a spectrometer for detecting an electromagnetic (EM) wave spectrum having one or more wavelength components within a spectral band of interest is provided, comprising an entrance aperture; an exit aperture; a dispersion and imaging optics configured to create dispersed images of the entrance aperture on a plane of the exit aperture, such that respective images at the different wavelength components are offset by different amounts of displacements along a direction of dispersion; at least one single-pixel detector, each single-pixel detector sensitive to one or more of the wavelength components; an EM detector; a first collection optics configured to gather a first EM wave energy incident on the entrance aperture to the EM detector; a second collection optics configured to gather a second EM wave energy that exits the exit aperture to the at least one single-pixel detector; and a measurement unit configured to measure the output of the EM detector and the output of the at least one single pixel detector for reconstructing the EM wave spectrum taking into account an intensity distribution of an incident EM wave on the entrance aperture.

The entrance aperture may comprise at least one entrance slit that is spatially encoded along a direction substantially transverse to the direction of dispersion.

The exit aperture may comprise a plurality of exit slits arranged in the direction of dispersion, where each exit slit is spatially encoded along a direction substantially transverse to the direction of dispersion.

An encoding pattern of the at least one entrance slits and/or an encoding pattern of the plurality of exit slits may be adjustable and configured to be changed for a number of times.

The first collection optics may be configured to gather the first EM wave energy from the zeroth order diffraction from a dispersion element of the dispersion and imaging optics.

The first collection optics may be configured to gather the first EM wave energy from a beam splitter element disposed near the entrance aperture.

The EM detector may comprise a single-pixel detector or an imaging camera.

The spectrometer may comprise a bandpass filter for filtering the spectral band of interest from the incident EM wave.

The spectrometer may comprise a first field lens configured for pupil matching with a fore optics, for disposal near the entrance aperture.

The spectrometer may comprise a second field lens configured for pupil matching with the second collection optics, for disposal near the exit aperture.

The second collection optics may comprise a dispersion element to remove the dispersion effects from the dispersion and imaging optics.

Adjustable encoding patterns of at least one of the entrance slit and/or the exit slit, respectively, may be implemented using microelectromechanical systems (MEMS) technology or using MEMS micromirror arrays.

Adjustable encoding patterns of at least one of the entrance slit and/or the exit slit, respectively, may be implemented using a movable mask placed in the vicinity of a fixed aperture opening.

The spectrometer may be configured as a Raman spectroscopy system. The spectrometer may be configured for time-gate and/or time-resolved Raman spectroscopy.

The measurement unit may be configured for using time correlated single photon counting (TCSPC), wherein 3D histogram data cubes are constructed with the EM detector and the at least the single-pixel detector. The measurement unit may be configured to slice the 3D histogram data cubes at various time delays, each time delay slice representing a complete set of encoded intensity measurements for reconstructing the Raman spectrum at that corresponding time delay. The measurement unit may be configured such that time-resolved Raman shift spectra are reconstructed at various time delays.

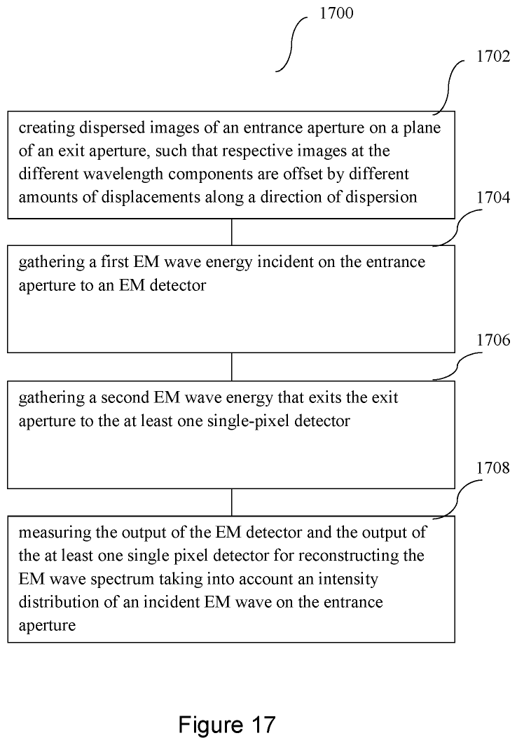

FIG. 17 shows a flow-chart 1700 illustrating a method of detecting an electromagnetic (EM) wave spectrum having one or more wavelength components within a spectral band of interest, according to an example embodiment. At step 1702, dispersed images of an entrance aperture are created on a plane of an exit aperture, such that respective images at the different wavelength components are offset by different amounts of displacements along a direction of dispersion. At step 1704, a first EM wave energy incident on the entrance aperture to an EM detector is gathered. At step 1706, a second EM wave energy that exits the exit aperture to the at least one single-pixel detector is gathered. At step 1708, the output of the EM detector and the output of the at least one single pixel detector are measured for reconstructing the EM wave spectrum taking into account an intensity distribution of an incident EM wave on the entrance aperture.

The method may comprise spatially encoding at least one entrance slit of the entrance aperture along a direction substantially transverse to the direction of dispersion.

The method may comprise spatially encoding a plurality of exit slits of the exit aperture along a direction substantially transverse to the direction of dispersion.

The method may comprise changing an encoding pattern of the at least one entrance slits and/or an encoding pattern of the plurality of exit slits for a number of times.

The first EM wave energy may be gathered from the zeroth order diffraction from a dispersion element.

The first EM wave energy may be gathered from a beam splitter element disposed near the entrance aperture.

The EM detector may comprise a single-pixel detector or an imaging camera.

The method may comprise filtering the spectral band of interest from the incident EM wave.

The method may comprise pupil matching with a fore optics.

The method may comprise pupil matching during gathering of the second EM wave energy to the at least one single-pixel detector.

The method may comprise removing dispersion effects from the creating of the dispersed images of the entrance aperture on the plane of an exit aperture.

Adjustable encoding patterns of at least one of the entrance slit and/or the exit slit, respectively, may be implemented using microelectromechanical systems (MEMS) technology or using MEMS micromirror arrays.

Adjustable encoding patterns of at least one of the entrance slit and/or the exit slit, respectively, may be implemented using a movable mask placed in the vicinity of a fixed aperture opening.

The method may be used for performing Raman spectroscopy. The method may be used for performing time-gate and/or time-resolved Raman spectroscopy.

The method may comprise using time correlated single photon counting (TCSPC), wherein 3D histogram data cubes are constructed with the EM detector and the at least the single-pixel detector. The method may comprise slicing the 3D histogram data cubes at various time delays, each time delay slice representing a complete set of encoded intensity measurements for reconstructing the Raman spectrum at that corresponding time delay. The method may comprise reconstructing time-resolved Raman shift spectra at various time delays.

In one embodiment, a method of constructing the spectrometer of any one of the example embodiments is provided.

Industrial applications of embodiments of the present invention include that the technology could be used to develop IR and/or Raman spectrometers with high throughput and high spectral resolution for field uses in a range of applications which include, but are not limited to, gas sensing, materials identification and verification, environment monitoring, sensors for internet of things (IoTs), biological science, food and beverage quality assessment, forensics and law enforcement, as well as pharmaceutical research and drug development.

Embodiments of the present invention can have one or more of the following features and associated benefits/advantages:

| Feature | Benefit/Advantage |
|---|---|
| Uses single-pixel | Cost-effective operation at UV and/or |
| photodetectors | IR wavelengths, where image sensors/ |
| | detector arrays are expensive. |
| | Cost-effective operation for ultrafast time- |
| | gated detection where intensified image |
| | sensors and streak cameras are expensive. |
| Enlarged entrance | Enabling high throughput thus |
| aperture instead of | significantly enhancing light-gathering |
| narrow slit | power and hence resulting in high SNR. |
| Detects both 0^{th} order | Removes requirement for uniform |
| and 1^{st} order diffraction | illumination on entrance aperture. |
| from a grating | Makes optical design easier and sample |
| | handling process simpler. |
| Use of enlarged entrance | High-throughput allows easier detection of |
| aperture high-throughput | weak Raman scattered signals. |
| single-pixel spectrometers | Single-pixel makes it easier and cost- |
| in Raman spectroscopy | effective to implement time-gated or time- |
| | resolved Raman spectroscopy to suppress |
| | fluorescence background. |
| Combines time correlated | Results in enhanced sensitivity in time- |
| single photon counting | resolve Raman spectroscopy. |
| (TCSPC) with enlarged | |
| entrance aperture high | |
| throughput design | |
| Use MEMS micromirrors to | Compact, no bulky mechanical moving |
| encode in TG/TR Raman | part, and robust |
| system | |

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A spectrometer for detecting an electromagnetic (EM) wave spectrum having one or more wavelength components within a spectral band of interest, comprising:
an entrance aperture;
an exit aperture;
a dispersion and imaging optics configured to create dispersed images of the entrance aperture on a plane of the exit aperture, such that respective images at the different wavelength components are offset by different amounts of displacements along a direction of dispersion;
at least one single-pixel detector, each single-pixel detector sensitive to one or more of the wavelength components;
an EM detector;
a first collection optics configured to gather a first EM wave energy incident on the entrance aperture to the EM detector;
a second collection optics configured to gather a second EM wave energy that exits the exit aperture to the at least one single-pixel detector; and
a measurement unit configured to measure the output of the EM detector and the output of the at least one single pixel detector for reconstructing the EM wave spectrum taking into account an intensity distribution of an incident EM wave on the entrance aperture.

2. The spectrometer of claim 1, wherein the entrance aperture comprises at least one entrance slit that is spatially encoded along a direction substantially transverse to the direction of dispersion.

3. The spectrometer of claim 1, wherein the exit aperture comprises a plurality of exit slits arranged in the direction of dispersion, where each exit slit is spatially encoded along a direction substantially transverse to the direction of dispersion.

4. The spectrometer of claim 1, wherein an encoding pattern of the at least one entrance slits and/or an encoding pattern of the plurality of exit slits is adjustable and configured to be changed for a number of times.

5. The spectrometer of claim 1, wherein the first collection optics is configured to gather the first EM wave energy from the zeroth order diffraction from a dispersion element of the dispersion and imaging optics.

6. The spectrometer of claim 1, wherein the first collection optics is configured to gather the first EM wave energy from a beam splitter element disposed near the entrance aperture.

7. The spectrometer of claim 1, wherein the EM detector comprises a single-pixel detector or an imaging camera, and or comprising a bandpass filter for filtering the spectral band of interest from the incident EM wave, and/or comprising a first field lens configured for pupil matching with a fore optics, for disposal near the entrance aperture, and/or comprising a second field lens configured for pupil matching with the second collection optics, for disposal near the exit aperture and/or wherein the second collection optics comprises a dispersion element to remove the dispersion effects from the dispersion and imaging optics, and/or wherein adjustable encoding patterns of at least one of the entrance slit and/or the exit slit, respectively, are implemented using microelectromechanical systems (MEMS) technology or using MEMS micromirror arrays.

8. (canceled)

9. (canceled)

10. (canceled)

11. (canceled)

12. (canceled)

13. The spectrometer of claim 1, wherein adjustable encoding patterns of at least one of the entrance slit and/or the exit slit, respectively, are implemented using a movable mask placed in the vicinity of a fixed aperture opening.

14. The spectrometer of claim 1, configured as a Raman spectroscopy system, and optionally configured for time-gate and/or time-resolved Raman spectroscopy.

15. (canceled)

16. The spectrometer of claim 14, wherein the measurement unit is configured for using time correlated single photon counting (TCSPC), wherein 3D histogram data cubes are constructed with the EM detector and the at least the single-pixel detector, and optionally wherein the measurement unit is configured to slice the 3D histogram data cubes at various time delays, each time delay slice representing a complete set of encoded intensity measurements for reconstructing the Raman spectrum at that corresponding time delay, wherein the measurement unit may be configured such that time-resolved Raman shift spectra are reconstructed at various time del.

17. (canceled)

18. (canceled)

19. A method of detecting an electromagnetic (EM) wave spectrum having one or more wavelength components within a spectral band of interest, the method comprising the steps of:
creating dispersed images of an entrance aperture on a plane of an exit aperture, such that respective images at the different wavelength components are offset by different amounts of displacements along a direction of dispersion;
gathering a first EM wave energy incident on the entrance aperture to an EM detector;
gathering a second EM wave energy that exits the exit aperture to the at least one single-pixel detector; and
measuring the output of the EM detector and the output of the at least one single pixel detector for reconstructing the EM wave spectrum taking into account an intensity distribution of an incident EM wave on the entrance aperture.

20. The method of claim 19, comprising spatially encoding at least one entrance slit of the entrance aperture along a direction substantially transverse to the direction of dispersion.

21. The method of claim 19, comprising spatially encoding a plurality of exit slits of the exit aperture along a direction substantially transverse to the direction of dispersion.

22. The method of claim 19, comprising changing an encoding pattern of the at least one entrance slits and/or an encoding pattern of the plurality of exit slits for a number of times.

23. The method of claim 19, wherein the first EM wave energy is gathered from the zeroth order diffraction from a dispersion element.

24. The method of claim 19, wherein the first EM wave energy is gathered from a beam splitter element disposed near the entrance aperture.

25. The method of claim 19, wherein the EM detector comprises a single-pixel detector or an imaging camera, and/or comprising filtering the spectral band of interest from the incident EM wave, and/or comprising pupil matching with a fore optics, and/or comprising pupil matching during gathering of the second EM wave energy to the at least one single-pixel detector, and/or comprising removing dispersion effects from the creating of the dispersed images of the entrance aperture on the plane of an exit aperture, and/or comprising removing dispersion effects from the creating of the dispersed images of the entrance aperture on the plane of an exit aperture, and/or wherein adjustable encoding patterns of at least one of the entrance slit and/or the exit slit, respectively, are implemented using microelectromechanical systems (MEMS) technology or using MEMS micromirror arrays, and/or The method of any one of claims 19 to 30, wherein adjustable encoding patterns of at least one of the entrance slit and/or the exit slit, respectively, are implemented using a movable mask placed in the vicinity of a fixed aperture opening.

26. (canceled)

27. (canceled)

28. (canceled)

29. (canceled)

30. (canceled)

31. (canceled)

32. The method of claim 19, for performing Raman spectroscopy, and optionally for performing time-gate and/or time-resolved Raman spectroscopy.

33. (canceled)

34. The method of claim 32, comprising using time correlated single photon counting (TCSPC), wherein 3D histogram data cubes are constructed with the EM detector and the at least the single-pixel detector, and optionally comprising slicing the 3D histogram data cubes at various time delays, each time delay slice representing a complete set of encoded intensity measurements for reconstructing the Raman spectrum at that corresponding time delay and further optionally comprising reconstructing time-resolved Raman shift spectra at various time delays.

35. (canceled)

36. (canceled)

37. A method of constructing the spectrometer of claim 1.
